(19) United States
(12) Patent Application Publication
(10) Pub. No.: US 2015/0262725 A1
(43) Pub. Date: Sep. 17, 2015

(54) COMPOSITE CONDUCTOR

(71) Applicant: Hitachi Metals, Ltd.

(72) Inventors: Hideyuki SAGAWA, Naka-gun (JP); Keisuke FUJITO, Mito (JP)

(21) Appl. No.: 14/626,336

(22) Filed: Feb. 19, 2015

(30) Foreign Application Priority Data
Mar. 17, 2014 (JP) 2014-053759

(51) Int. Cl. H01B 1/02; C22C 9/00; C22C 14/00; B32B 15/01; B32B 15/20

(52) U.S. Cl. CPC H01B 1/026; B32B 15/01; B32B 15/20; C22C 14/00; C22C 9/00; B32B 2307/202

(57) ABSTRACT

A composite conductor is composed of a core including a titanium or a titanium alloy, a cladding layer including a copper and being provided to clad an outer periphery of the core, and an intermetallic compound layer being formed by diffusions of the titanium or titanium alloy included in the core and the copper included in the cladding layer, and being provided between the core and the cladding layer.

The present application is based on Japanese patent application No. 2014-53759 filed on Mar. 17, 2014, the entire contents of which are incorporated herein by reference.

### BACKGROUND OF THE INVENTION

1. Field of the Invention

The present invention relates to a composite conductor.

2. Description of the Related Art

A conductor used for e.g. a cable such as a headphone cord or the like is required to be reduced in weight. For that reason, although as the conductor, a copper conductor composed of copper was used in the past, an aluminum conductor composed of aluminum which is lighter than copper has been studied. However, there is the problem that the aluminum conductor, although lighter than the copper conductor, has a lower electrical conductivity than that of the copper conductor.

In view of the foregoing problem, in order to reconcile the lighter weight conductor and the higher electrical conductivity, there has been suggested a composite conductor whose core is made of an aluminum conductor and formed with a cladding layer made of copper to clad a circumference of the core, i.e. so-called copper clad aluminum wire (Refer to e.g. JP-A 4-230905). This composite conductor is lighter than a copper conductor of the same diameter, and in the case of high frequency transmission applications, has an electrical conductivity of the same order as that of the copper conductor.

### SUMMARY OF THE INVENTION

In the composite conductor described in the above mentioned JP-A-4-230905, however, the aluminum used as the core is weak in mechanical strength, and therefore has the problem that the composite conductor tends to break due to a bending or repeated bendings during wire drawing or during use as a product. There is also the problem that during its production or use, the adhesion between the core and the cladding layer lowers, thus the cladding layer tending to be separated from the core.

In view of the above problems, it is an object of the present invention to provide a composite conductor, which is unlikely to cause wire breaking, and whose cladding layer is unlikely to be separated from its core.

(b 1) According to one embodiment of the invention, a composite conductor comprises:

a core including a titanium or a titanium alloy;

a cladding layer including a copper and being provided to clad an outer periphery of the core; and

an intermetallic compound layer being formed by diffusions of the titanium or titanium alloy included in the core and the copper included in the cladding layer, and being provided between the core and the cladding layer.

In one embodiment, the following modifications and changes may be made.

(i) The intermetallic compound layer is not smaller than 0.1 μm and not greater than 5.0 μm in thickness.

(ii) A cross sectional area of the cladding layer is not smaller than 2 percent and not greater than 50 percent of a total cross sectional area of the composite conductor.

(2) According to another embodiment of the invention, a composite conductor comprises:

a core including a titanium or a titanium alloy;

a cladding layer including a copper and being provided to clad an outer periphery of the core;

an interlayer including a molybdenum or vanadium and being provided to be interposed between the core and the cladding layer;

a first intermetallic compound layer being formed by diffusions of the titanium or titanium alloy included in the core and the molybdenum or vanadium included in the interlayer, and being provided between the core and the interlayer; and

a second intermetallic compound layer being formed by diffusions of the molybdenum or vanadium included in the interlayer and the copper included in the cladding layer, and being provided between the interlayer and the cladding layer.

In another embodiment, the following modifications and changes may be made.

(i) The interlayer is not smaller than 0.2 μm and not greater than 1 μm in thickness.

(ii) The first intermetallic compound layer is not smaller than 0.1 μm and not greater than 10 μm in thickness, and the second intermetallic compound layer is not smaller than 0.1 μm and not greater than 4 μm in thickness.

(iii) A cross sectional area of the cladding layer including the copper is not smaller than 2 percent and not greater than 50 percent of a total cross sectional area of the composite conductor.

(Points of the Invention)

The present invention allows for providing the composite conductor, which is unlikely to cause wire breaking, and whose cladding layer is unlikely to be separated from its core.

### BRIEF DESCRIPTION OF THE DRAWINGS

The preferred embodiments according to the invention will be explained below referring to the drawings, wherein:

FIG. 1 is a cross sectional view showing a composite conductor in a first embodiment according to the present invention;

FIG. 2 is a cross sectional view showing a composite conductor in a second embodiment according to the present invention; and

FIG. 3 is a cross sectional view showing a composite conductor in another embodiment according to the present invention.

### DETAILED DESCRIPTION OF THE PREFERRED EMBODIMENTS

The inventors have examined a tendency of a cladding layer to be separated from a core in a copper clad aluminum wire as a composite conductor, and found that this separation is caused by an intermetallic compound layer, which is formed between the core and the cladding layer.

The intermetallic compound layer is formed between the core and the cladding layer during production of the copper clad aluminum wire. In general, copper clad aluminum wires are produced by wire drawing, i.e. material (parent material) pulling, elongating and decreasing in diameter, and annealing (heating). In the copper clad aluminum wire which undergoes working including heating, etc., a constituent aluminum (Al) of the core (Al included in the core) and a constituent copper (Cu) of the cladding layer (Cu included in the cladding core) are activated and diffused by heating. These metal diffusions result in an intermetallic compound layer composed of an intermetallic compound (Al—Cu compound) of Al and Cu, between the core and the copper cladding layer.

This intermetallic compound layer exists between the core and the cladding layer, and contributes to these adhesions. However, the intermetallic compound layer is mechanically brittle, and when grown thick by heating, likely to be cracked. The crack formation in the intermetallic compound layer existing between the core and the cladding layer causes the cladding layer to be separated from the core. As well as during the copper clad aluminum wire production, during use of the copper clad aluminum wire, the intermetallic compound layer is likely to be grown thick due to heating. Consequently, the cladding layer is likely to be separated from the core.

As described above, in the copper clad aluminum wire, the adhesion between the core and the cladding layer is ensured by the intermetallic compound layer, but due to heating, the intermetallic compound layer is grown thick and cracked, thus causing the cladding layer to be separated from the core.

From the above contemplation, in order to suppress the separation of the cladding layer, it is considered desirable that a constituent metal of the core and a constituent metal of the cladding layer are unlikely to diffuse due to heating, in other words, the intermetallic compound layer is unlikely to be grown thick due to heating. In view of the foregoing, the inventors have examined the constituent metal of the core, so that Cu is used for the cladding layer from the point of view of electrical conductivity. This examination has resulted in a finding that titanium (Ti) or a titanium alloy (Ti alloy) is preferable for the constituent metal of the core. It has been found that, even when the Ti or the Ti alloy, which is generally considered as an active metal, forms an intermetallic compound layer between the Ti or the Ti alloy and the constituent Cu of the cladding layer, that intermetallic compound layer is unlikely to be grown thick due to heating. The use of the Ti or Ti alloy for the core of the composite conductor therefore allows for, during its production or use, suppressing the crack formation in the intermetallic compound layer due to heating, and the resulting separation of the cladding layer from the core. Also, the use of the Ti or Ti alloy having high mechanical strength for the core in place of the conventional Al allows for the composite conductor to withstand a severe bending, repeated bendings, etc., and be unlikely to cause wire breaking.

Further, the inventors have found that the core composed of the Ti or Ti alloy and the cladding layer composed of the Cu may have an interlayer interposed therebetween that is composed of molybdenum (Mo) or vanadium (V) which is unlikely to form an intermetallic compound of the Ti and the Cu. This allows for further suppressing the increase in the intermetallic compound layer thickness formed between the core and the cladding layer. The provision of the interlayer including Mo or V therefore allows for suppressing the separation of the cladding layer from the core.

The present invention has been made based on the above findings.

### First Embodiment of the Present Invention

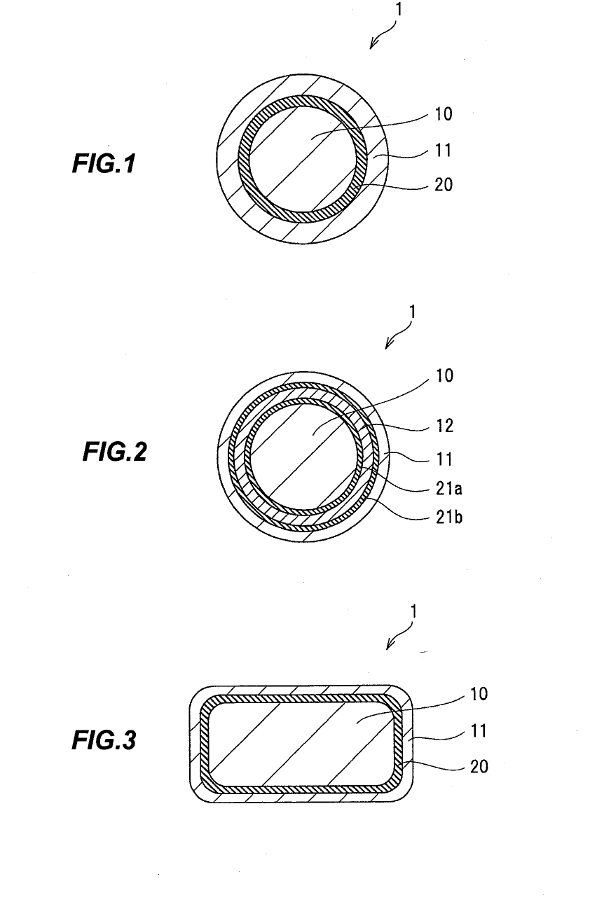

A first embodiment of the present invention is described below. FIG. 1 is a cross sectional view showing a composite conductor 1 in the first embodiment of the present invention.

(1) Composite Conductor Configuration

The composite conductor 1 in the present embodiment as shown in FIG. 1 is composed of a core 10 including titanium (Ti) or a titanium alloy (Ti alloy), a cladding layer 11 including copper (Cu) and being provided to clad a circumference of that core 10, and an intermetallic compound layer 20 provided between the core 10 and the cladding layer 11, and including an intermetallic compound formed by diffusions of the Ti or the Ti alloy and the Cu.

The core 10 is formed of the Ti or Ti alloy. The Ti alloy contains primarily Ti, and the remainder contains e.g. at least one of Al, Sn, Mo, V, Zr, Fe, Cr, Cu, and Ni. The core 10 may be preferably not smaller than 10 μm and not greater than 20 mm, more preferably not smaller than 0.1 mm and not greater than 10 mm in diameter.

The cladding layer 11 is provided to clad the circumference of the core 10. The cladding layer 11 is formed of Cu, such as tough pitch copper (TPC) and oxygen free copper (OFC). The cladding layer 11 may be preferably not smaller than 0.1 μm and not greater than 5 mm, more preferably not smaller than 2 μm and not greater than 2 mm in thickness. Also, the cross sectional area of the cladding layer 11 may be preferably not smaller than 2 percent and not greater than 50 percent, more preferably not smaller than 5 percent and not greater than 30 percent of the total cross sectional area of the composite conductor 1. Setting the cross sectional area ratio of the cladding layer 11 to the entire composite conductor 1 at not smaller than 2 percent allows a lowering in the resistance of the composite conductor 1, esp. the high-frequency resistance thereof. On the other hand, setting the cross sectional area ratio of the cladding layer 11 to the entire composite conductor 1 at not greater than 50 percent lowers the proportion of Cu with high specific gravity, thereby allowing a reduction in weight of the composite conductor 1. Note that the total cross sectional area of the composite conductor 1 refers to the total cross sectional area of the core 10, the cladding layer 11 and the intermetallic compound layer 20.

The intermetallic compound layer 20 is provided between the core 10 and the cladding layer 11, and contributes to the adhesion between the core 10 and the cladding layer 11. The intermetallic compound layer 20 is made from an intermetallic compound formed by the constituent Ti or Ti alloy of the core 10 and the constituent Cu of the cladding layer 11 being diffused by heating when producing the composite conductor 1. Specifically, the intermetallic compound layer 20 is made from a Ti—Cu compound. In this embodiment, because the core 10 is composed of the Ti or Ti alloy, it is possible to, when heating the composite conductor 1, suppress the Ti and Cu diffusions, and suppress the growth of the intermetallic compound layer 20 resulting from those diffusions. In other words, it is possible to suppress the increase in the thickness of the intermetallic compound layer 20 due to heating.

The thickness of the intermetallic compound layer 20 may be such a thickness as to ensure the adhesion between the core 10 and the cladding layer 11, and prevent the crack formation in the intermetallic compound layer 20. The inventors have found that when the thickness of the intermetallic compound layer 20 is not smaller than 0.1 μm, it is possible to ensure that adhesion, while when the thickness of the intermetallic compound layer 20 is not greater than 5.0 μm, it is possible to suppress the crack formation in the intermetallic compound layer 20. Therefore, the thickness of the intermetallic compound layer 20 is preferably not smaller than 0.1 μm and not greater than 5.0 μm, more preferably not smaller than 0.1 μm and not greater than 2.0 μm. Setting the thickness of the intermetallic compound layer 20 at not smaller than 0.1 μm and not greater than 5.0 μm makes it possible to ensure the adhesion between the core 10 and the cladding layer 11, and prevent the crack formation in the intermetallic compound layer 20. Further, since it is possible to ensure the intermetallic compound layer 20 thickness tolerance to crack formation, it is possible to, when placing the composite conductor 1 in a heating environment, enhance its durability.

The intermetallic compound layer 20 includes the intermetallic compound formed of the Ti or Ti alloy and the Cu, and is preferably configured so that the Cu concentration is higher than the Ti concentration. The configuration of the intermetallic compound layer 20 including the relatively much Cu more flexible than the Ti allows for making the intermetallic compound layer 20 flexible. This allows the intermetallic compound layer 20 to follow and adhere to the core 10 and the cladding layer 11 and thereby enhance the adhesion between the core 10 and the cladding layer 11.

The outer diameter of the composite conductor 1 may be preferably not smaller than 10 μm and not greater than 26 mm, more preferably not smaller than 15 μm and not greater than 15 mm.

(2) Production Method for the Composite Conductor

Next, a production method for the above-described composite conductor 1 is described. Note that the production method described below is one example, but is not particularly limited thereto.

(Parent Material Forming Step)

First, as the core 10, a Ti core including Ti or a Ti alloy having a circular cross section and a diameter of e.g. 4 mm is prepared. As the cladding layer 11, a cylindrical Cu pipe (Cu tube) including Cu having an outer diameter of 6 mm, an inner diameter of 4.2 mm, and a thickness of 1.8 mm is prepared such that the Ti core can be inserted therein. Following that, the Ti core is inserted into the Cu tube to form a parent material having an outer diameter of 6 mm.

(Wire Drawing Step)

Following that, the resulting parent material is inserted into a wire drawing die and drawn into a wire. The wire drawing die has an inlet, a wire drawing portion smaller in diameter than the inlet, and an outlet. The parent material is introduced from the inlet of the wire drawing die into the wire drawing die, worked by the wire drawing portion into an outer diameter smaller than an undrawn wire outer diameter, and drawn out from the outlet. In this embodiment, a plurality of the wire drawing dies are used to draw the parent material on the plurality of paths and thereby successively reduce the outer diameter of the parent material to form the drawn wire. Specifically, the parent material of 6 mm outer diameter is reduced in diameter by the plurality of wire drawing dies to form the drawn wire of 0.9 mm outer diameter. Here, in the resulting drawn wire, the diameter of the core 10 is 0.74 mm, the thickness of the cladding layer 11 is 0.08 mm, and the cross sectional area ratio of the cladding layer 11 to the drawn wire is 32 percent.

In the wire drawing step, the degree of processing when the parent material is drawn into the wire to form the drawn wire may be e.g. not lower than 5 percent and not higher than 99 percent, preferably not lower than 25 percent and not higher than 98 percent. Note that the degree of processing refers to a cross sectional area ratio of the drawn wire to the undrawn parent material. In the case of the wire drawing on the plurality of paths with the plurality of wire drawing dies, the degree of processing in each wire drawing die may be adjusted so that the degree of processing is within the above-mentioned range.

The wire drawing of the parent material in the wire drawing step causes shear stress in its wire drawing direction in the parent material. This stress causes shear heating in the parent material. That is, the parent material is heated by the wire drawing step. As a result, in the drawn wire formed by the parent material drawing, between the core 10 and the cladding layer 11, the constituent Ti or Ti alloy of the core 10 and the constituent Cu of the cladding layer 11 are diffused to form the intermetallic compound layer 20 including their respective components.

(Annealing Step)

Following that, the drawn wire resulting from the wire drawing step is annealed (heated), resulting in the composite conductor 1 in the present embodiment. In the annealing step, the heating of the drawn wire mitigates the working deformation of the drawn wire caused in the wire drawing step. Here, although the metal diffusions between the core 10 and the cladding layer 11 are promoted and the intermetallic compound layer 20 is likely to be grown thick, because the Ti or Ti alloy is used as the core 10 in the present embodiment, it is possible to suppress the increase in the thickness of the intermetallic compound layer 20 due to the heating. This makes it possible to suppress the crack formation in the intermetallic compound layer 20 and the resulting separation of the cladding layer 11 during the production of the composite conductor 1. In the annealing step, the heating may be performed so that the thickness of the intermetallic compound layer 20 is e.g. not smaller than 0.1 μm and not greater than 5.0 μm.

In the annealing step, the conditions for the heating of the drawn wire are not particularly limited as long as the intermetallic compound layer 20 is not excessively grown. For example, the heating temperature may be not lower than 50 degrees Celsius and not higher than 800 degrees Celsius, and the heating time may be not shorter than 5 seconds and not longer than 5 hours. Preferably the heating temperature may be not lower than 50 degrees Celsius and not higher than 500 degrees Celsius, and the heating time may be not shorter than 10 seconds and not longer than 5 hours.

Note that although in this embodiment it has been described that the Ti core is inserted into the cylindrical Cu pipe to form the parent material, the parent material provided with a Cu foil cladded around the circumference of the Ti core may be formed by cladding the Cu foil of a predetermined thickness around the circumference of the Ti core and welding its seam. Also, a Cu plating layer as the cladding layer 11 may be formed by plating directly around the circumference of the Ti core.

(3) Advantageous Effects of the Present Embodiment

The present embodiment has one or more advantageous effects described below.

(a) In the composite conductor 1 in the present embodiment, the core 10 is composed of the Ti or Ti alloy which is unlikely to be diffused due to heating. Therefore, even when the composite conductor 1 is heated during its production or use, it is possible to suppress the diffusions of the Ti or Ti alloy of the core 10 and the Cu of the cladding layer 11 and suppress the growth of the intermetallic compound layer 20 formed by those diffusions. In other words, it is possible to suppress the increase in the thickness of the intermetallic compound layer 20 due to the heating. This makes it possible to suppress the crack formation in the composite conductor 1 due to the increase in the thickness of the intermetallic compound layer 20 and the resulting separation of the cladding layer 11 from the core 10.

(b) In the composite conductor 1 in the present embodiment, because the core 10 is composed of the Ti or Ti alloy which is higher in strength than aluminum, it is possible to suppress the wire break, in comparison with the copper clad aluminum wire of the same diameter.

(c) In the composite conductor 1 in the present embodiment, the core 10 is composed of the Ti or Ti alloy which is lighter than Cu. It is therefore possible to reduce the weight of the composite conductor 1, in comparison with the copper conductor of the same diameter.

(d) For the composite conductor 1 in the present embodiment, the thickness of the intermetallic compound layer 20 may be set at not smaller than 0.1 μm and not greater than 5.0 μm. Setting the thickness of the intermetallic compound layer 20 in the above described range makes it possible to enhance the adhesion between the core 10 and the cladding layer 11. Further, since it is possible to ensure the intermetallic compound layer 20 thickness tolerance to crack formation in the composite conductor 1, it is possible to, when placing the composite conductor 1 in a heating environment, enhance its durability.

(e) For the composite conductor 1 in the present embodiment, the cross sectional area ratio of the cladding layer 11 to the entire composite conductor 1 may be set at not smaller than 2 percent and not greater than 50 percent. Setting the cross sectional area ratio of the cladding layer 11 to the entire composite conductor 1 in the above described range allows a lowering in high-frequency resistance value in the cladding layer 11. This allows a further enhancement in the high frequency properties of the composite conductor 1.

### Second Embodiment of the Present Invention

Next, a second embodiment of the present invention is described. Note that, here, only its differences from the first embodiment are described. FIG. 2 is a cross sectional view showing a composite conductor 1 in the second embodiment of the present invention.

The composite conductor 1 in the second embodiment as shown in FIG. 2 is different from that of the above described first embodiment in that: between the core 10 including the Ti or the Ti alloy and the cladding layer 11 including the Cu, there is provided an interlayer 12 including molybdenum (Mo) or vanadium (V); between the core 10 and the interlayer 12, there is provided a first intermetallic compound layer 21a which is formed by diffusions of the constituent Ti or Ti alloy of the core 10 and the constituent Mo or V of the interlayer 12; and between the interlayer 12 and the cladding layer 11, there is provided a second intermetallic compound layer 21b which is formed by diffusions of the constituent Mo or V of the interlayer 12 and the constituent Cu of the cladding layer 11.

The interlayer 12 includes the Mo or the V. These metals are unlikely to be diffused with the constituent Ti of the core 10 and the constituent Cu of the cladding layer 11 and unlikely to form an intermetallic compound with the Ti and the Cu. The thickness of the interlayer 12 is not particularly limited as long as it allows metal diffusion with each of the core 10 and the cladding layer 11, and good adhesions between it and the core 10 and the cladding layer 11. The thickness of the interlayer 12 is preferably not smaller than 0.2 μm and not greater than 1 μm, more preferably not smaller than 0.2 μm and not greater than 50 μm.

The first intermetallic compound layer 21a is provided between the core 10 and the interlayer 12, and contributes to the adhesion between the core 10 and the interlayer 12. The first intermetallic compound layer 21a is made from an intermetallic compound formed by diffusions of the constituent Ti or Ti alloy of the core 10 and the constituent Mo or V of the interlayer 12. Specifically, the first intermetallic compound layer 21a is made from a Ti—Mo compound or a Ti—V compound. In this embodiment, because each of the Ti, Mo and V is the metal which is unlikely to be diffused by heat, the first intermetallic compound layer 21a including these metals is unlikely to be grown by heating, and the increase in the thickness due to the growth is suppressed.

The second intermetallic compound layer 21b is provided between the interlayer 12 and the cladding layer 11, and contributes to the adhesion between the interlayer 12 and the cladding layer 11. The second intermetallic compound layer 21b is made from an intermetallic compound formed by diffusions of the constituent Mo or V of the interlayer 12 and the constituent Cu of the cladding layer 11. Specifically, the second intermetallic compound layer 21b is made from a Mo—Cu compound or a V—Cu compound. In this embodiment, because each of the Mo and V is the metal which is unlikely to be diffused by heat, the second intermetallic compound layer 21b including these metals is unlikely to be grown by heating, and the increase in the thickness due to the growth is suppressed.

The thicknesses of the first intermetallic compound layer 21a and the second intermetallic compound layer 21b are not particularly limited as long as they ensure their respective adhesions and no crack forms therein. The thickness of the first intermetallic compound layer 21a is preferably not smaller than 0.1 μm and not greater than 4 μm, more preferably not smaller than 0.1 μm and not greater than 2 μm. The thickness of the second intermetallic compound layer 21b is preferably not smaller than 0.1 μm and not greater than 4 μm, more preferably not smaller than 0.1 μm and not greater than 2 μm. Setting the respective thicknesses of the first intermetallic compound layer 21a and the second intermetallic compound layer 21b in the above described range makes it possible to enhance their respective adhesions. Further, it is possible to have the first intermetallic compound layer 21a and the second intermetallic compound layer 21b thickness tolerances to crack formation in the composite conductor 1, and it is possible to, when placing the composite conductor 1 in a heating environment, enhance its durability.

In this embodiment, the composite conductor 1 is provided with the interlayer 12 including the Mo or the V interposed between the core 10 and the cladding layer 11, and includes the intermetallic compound layer 21a formed between the core 10 and the interlayer 12, and the intermetallic compound layer 21b formed between the interlayer 12 and the cladding layer 11. Therefore, in the composite conductor 1 in the present embodiment, it is also possible to suppress the crack formation in the intermetallic compound layers 21a and 21b due to heating and the resulting separation of the cladding layer 11 from the core 10, in the same manner as in the above described first embodiment. Besides, in the present embodiment, because the interlayer 12 is composed of the Mo or the V which is more unlikely to be diffused, it is possible to further suppress the increase in the thickness of the intermetallic compound layers 21a and 21b due to heating, in comparison with the first embodiment.

The composite conductor 1 in the present embodiment can be produced as follows, for example.

(Parent Material Forming Step)

In the parent material forming step, the Mo foil including the Mo as the interlayer 12 and the Cu foil including the Cu as the cladding layer 11 are first laminated together to form a laminated foil. The parent material is formed by cladding this laminated foil around the circumference of the Ti core as the core 10 in such a manner that the Mo foil is arranged around an inner side while the Cu foil is arranged around an outer side, and welding its seam. Note that the outer diameter of the parent material is 4.6 mm, the diameter of the Ti core is 4.0 mm, the thickness of the Mo foil is 0.1 mm, and the thickness of the Cu foil is 0.2 mm.

(Wire Drawing Step)

Following that, the resulting parent material is inserted into a wire drawing die and drawn into a wire. The parent material of 4.6 mm outer diameter is reduced in diameter by a plurality of the wire drawing dies to form the drawn wire of 0.525 mm outer diameter. Here, in the resulting drawn wire, the diameter of the core 10 is 0.375 mm, the thickness of the interlayer 12 is 0.025 mm, the thickness of the cladding layer 11 is 0.05 mm, and the cross sectional area ratio of the cladding layer 11 to the drawn wire is 21 percent. In the wire drawing step, the drawn wire is formed with the first intermetallic compound layer 21a between the core 10 and the interlayer 12, and the second intermetallic compound layer 21b between the interlayer 12 and the cladding layer 11.

(Annealing Step)

Following that, the drawn wire resulting from the wire drawing step is annealed (heated), resulting in the composite conductor 1 in the present embodiment. In the annealing step, although the metal diffusions are likely to be promoted between the core 10 and the interlayer 12 and between the interlayer 12 and the cladding layer 11, because the core 10, the interlayer 12 and the cladding layer 11 are composed of the metals, respectively, which are unlikely to be diffused by heat, it is possible to suppress the increases in the thicknesses of the first intermetallic compound layer 21a and the second intermetallic compound layer 21b due to the heating. This makes it possible to suppress the crack formation in the intermetallic compound layers 21a and 21b and the resulting separation of the cladding layer 11 during the production of the composite conductor 1. In the annealing step, the heating may be performed so that the thickness of the first intermetallic compound layer 21a is e.g. not smaller than 0.1 μm and not greater than 4 μm, and the thickness of the second intermetallic compound layer 21b is e.g. not smaller than 0.1 μm and not greater than 4 μm.

Note that although in this embodiment it has been described that in the parent material forming step, the laminated foil is formed by laminating the Cu foil with the Mo foil, the laminated foil may also be formed by e.g. sputtering forming the Mo foil over the Cu foil. Also, in the same manner as in the above described first embodiment, the parent material may be formed by preparing a Ti core including Ti or a Ti alloy, a cylindrical Mo pipe including Mo as the interlayer 12 for the Ti core to be inserted therein, and a cylindrical Cu pipe including Cu for the Mo pipe to be inserted therein, inserting the Mo pipe into the Cu pipe, and inserting the Ti core into the Mo pipe.

Note that although in the above described first and second embodiments, it has been described that the composite conductor 1 is circular in cross sectional shape, the present invention is not limited thereto. For example, as shown in FIG. 3, the composite conductor 1 may have a flat rectangular cross sectional shape. Also, the composite conductor 1 may have an irregular cross sectional shape such as that to be used for a trolley wire (contact wire) for an electric train.

### Preferred Embodiments of the Present Invention

Below are listed the aspects of the present invention.

(Aspect 1)

According to Aspect 1 of the invention, a composite conductor comprises:

a core including a titanium or a titanium alloy;

a cladding layer including a copper and being provided to clad an outer periphery of the core; and

an intermetallic compound layer being formed by diffusions of the titanium or titanium alloy included in the core and the copper included in the cladding layer, and being provided between the core and the cladding layer.

(Aspect 2)

In the composite conductor according to Aspect 1, it is preferable that the intermetallic compound layer is not smaller than 0.1 μm and not greater than 5.0 μm in thickness.

(Aspect 3)

In the composite conductor according to Aspect 1 or 2, it is preferable that a cross sectional area of the cladding layer is not smaller than 2 percent and not greater than 50 percent of a total cross sectional area of the composite conductor.

(Aspect 4)

According to Aspect 4 of the present invention, a composite conductor comprises:

a core including a titanium or a titanium alloy;

a cladding layer including a copper and being provided to clad an outer periphery of the core;

an interlayer including a molybdenum or vanadium and being provided to be interposed between the core and the cladding layer;

a first intermetallic compound layer being formed by diffusions of the titanium or titanium alloy included in the core and the molybdenum or vanadium included in the interlayer, and being provided between the core and the interlayer; and

a second intermetallic compound layer being formed by diffusions of the molybdenum or vanadium included in the interlayer and the copper included in the cladding layer, and being provided between the interlayer and the cladding layer.

(Aspect 5) In the composite conductor according to Aspect 4, it is preferable that the interlayer is not smaller than 0.2 μm and not greater than 1 μm in thickness.

(Aspect 6)

In the composite conductor according to Aspect 4 or 5, it is preferable that the first intermetallic compound layer is not smaller than 0.1 μm and not greater than 10 μm in thickness, and the second intermetallic compound layer is not smaller than 0.1 μm and not greater than 4 μm in thickness.

(Aspect 7)

In the composite conductor according to any one of Aspects 4-6, it is preferable that the cross sectional area of the cladding layer including the copper is not smaller than 2 percent and not greater than 50 percent of the total cross sectional area of the composite conductor.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A composite conductor, comprising:
a core including a titanium or a titanium alloy;
a cladding layer including a copper and being provided to clad an outer periphery of the core; and
an intermetallic compound layer being formed by diffusions of the titanium or titanium alloy included in the core and the copper included in the cladding layer, and being provided between the core and the cladding layer.

2. The composite conductor according to claim 1, wherein the intermetallic compound layer is not smaller than 0.1 μm and not greater than 5.0 μm in thickness.

3. The composite conductor according to claim 1, wherein a cross sectional area of the cladding layer is not smaller than 2 percent and not greater than 50 percent of a total cross sectional area of the composite conductor.

4. A composite conductor, comprising:
a core including a titanium or a titanium alloy;
a cladding layer including a copper and being provided to clad an outer periphery of the core;
an interlayer including a molybdenum or vanadium and being provided to be interposed between the core and the cladding layer;
a first intermetallic compound layer being formed by diffusions of the titanium or titanium alloy included in the core and the molybdenum or vanadium included in the interlayer, and being provided between the core and the interlayer; and
a second intermetallic compound layer being formed by diffusions of the molybdenum or vanadium included in the interlayer and the copper included in the cladding layer, and being provided between the interlayer and the cladding layer.

5. The composite conductor according to claim 4, wherein the interlayer is not smaller than 0.2 μm and not greater than 1 μm in thickness.

6. The composite conductor according to claim 4, wherein the first intermetallic compound layer is not smaller than 0.1 μm and not greater than 10 μm in thickness, and the second intermetallic compound layer is not smaller than 0.1 μm and not greater than 4 μm in thickness.

7. The composite conductor according to claim 4, wherein a cross sectional area of the cladding layer including the copper is not smaller than 2 percent and not greater than 50 percent of a total cross sectional area of the composite conductor.
